(19) United States
(12) Patent Application Publication
(10) Pub. No.: US 2003/0044567 A1
(43) Pub. Date: Mar. 6, 2003

(54) Adhesive tape for closing bags

(76) Inventor: Oliver Jevons, Macclesfield (GB)

Correspondence Address: Timothy A. Cassidy, Dority & Manning, Attorneys at Law, P.A., P.O. Box 1449, Greenville, SC, 29602, US

(21) Appl. No.: 09/908,477

(22) Filed: Jul. 18, 2001

(30) Foreign Application Priority Data
Jan. 23, 1999 (GB) 9901453.2

(51) Int. Cl. B32B 9/00

(52) U.S. Cl. 428/77; 428/194; 428/124

(57) ABSTRACT

There is disclosed a spool of adhesive tape adapted for use in sealing the opening of a plastic bag by being wrapped around a gathered open end of the bag, the tape being characterized in that an edge region of an adhesive face is non-adhesive.

This invention concerns adhesive tape of the kind used to seal the opening of a bag of plastics material by being lapped around a gathered open end of the bag.

The sealing is normally effected by passing the neck downwardly through a slot of a sealing machine whose sides are defined by a spring-loaded anvil and a roller carrying the leading end of a supply of tape with the adhesive side of the tape facing the anvil and into the nip between a pair of spring-loaded levers, one of which carries a blade to sever the end of the tape. The machine operates to fold a length of the tape around the neck with the free ends of the length beyond the fold adhered together.

A problem arises in that it is very difficult to separate the adhered ends when it is desired to open the bag with the intention of reclosing. This problem has been solved by adapting the machinery to attach tabs to the ends so that there is a short region of unadhered tape which can be used to pull the adhered section apart. This is, however, quite expensive—the machinery has to be specially adapted, and the cost of the tab material—taken over, say, a year's operation is—substantial.

The present invention provides an adhesive tape which overcomes the problem aforesaid in a different, less expensive and more convenient way.

The invention comprises a spool of adhesive tape adapted for use in sealing the opening of a plastic bag by being lapped around a gathered open end of the bag, the tape being characterised in that an edge region of an adhesive face is non-adhesive.

The edge region may be rendered non-adhesive by not coating such edge with adhesive.

The edge region may be rendered non-adhesive by overlaying adhesive material on the edge with a non-adhesive material such as paper or plastics film.

The edge region may be rendered non-adhesive by folding a tape with adhesive over its entire width upon itself along the edge.

The non-adhesive edge region may be rendered visibly different, e.g. by being a different colour, from the rest.

The invention will be further apparent from the following description with reference to the several figures of the accompanying drawing which show, by way of example only, a number of forms of tape embodying same.

Of the drawing:

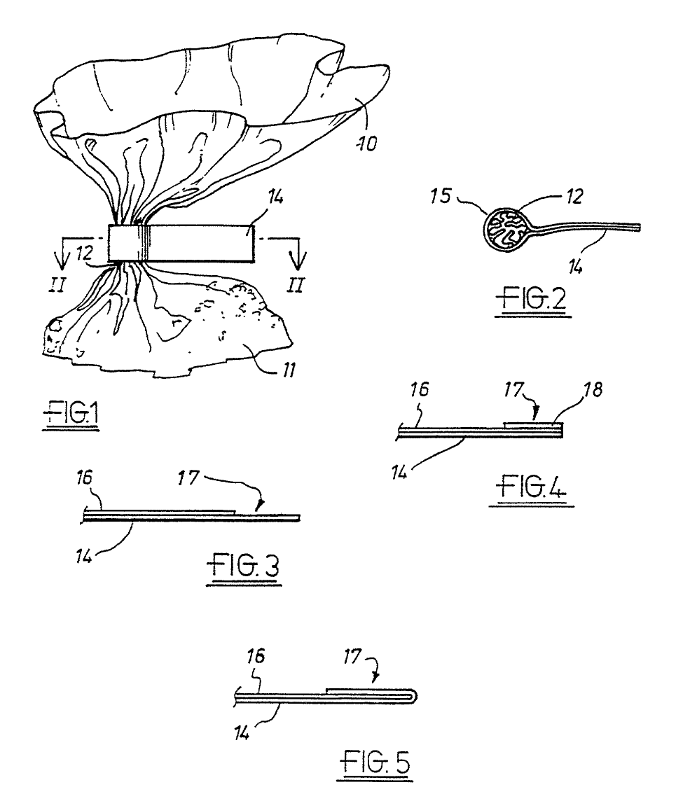

FIG. 1 shows the open end of a bag of plastics material closed and sealed by a tape of the invention;

FIG. 2 shows a cross-section of the seal on the line II-II of FIG. 1;

FIG. 3 shows a transverse-section through a first form of tape;

FIG. 4 shows a transverse-section through a second form of tape; and

FIG. 5 shows a transverse-section through a third form of tape.

Referring firstly to FIGS. 1 and 2, it will be seen that the open end 10 of bag 11 of plastics material is closed by twisting or compressing the sides of the bag 11 into a narrow neck 12.

The neck 12 is secured by a short length of tape 14 coated with adhesive material on one side folded around the neck with its free ends to the side of the fold 15 adhered together.

It will be understood that the precise details of any machine used to apply the tape do not form part of the invention and will not be discussed further.

A tape embodying the invention has at least one of its longitudinal edges of its side to which adhesive has been applied with non-adhesive characteristics.

FIG. 3 shows a tape 14 with adhesive 16 applied to one of its faces over part only of the width of the tape leaving an edge region 17 which is non-adhesive.

FIG. 4 shows a tape 14 with adhesive 16 applied to one of its faces over the entire width of the tape but with an edge region 17 rendered non-adhesive by an overlaying strip 18 of non-adhesive material such as paper or plastics film.

FIG. 5 shows a tape 14 with adhesive 16 supplied to one of its faces over the entire width of the tape but with one edge of the tape folded upon itself to provide a non-adhesive region 17.

With any closure made with these tapes, it is simple to separate the adhered ends by peeling apart from edge regions which are not adhered together.

Correct mounting on a bag sealing machine, and easy location of the unadhered region for separation, may be facilitated by making it visibly different from the rest, e.g. by colour.

It will be appreciated that it is not intended to limit the invention to the above example only, many variations, such as might readily occur to one skilled in the art, being possible, without departing from the scope thereof.

1. A spool of adhesive tape adapted for use in sealing the opening of a plastic bag by being lapped around a gathered open end of the bag, the tape being characterised in that an edge region of an adhesive face is non-adhesive.

2. A spool according to claim 1, in which the edge region is non-adhesive by virtue of having no adhesive.

3. A spool according to claim 1, in which the edge region is non-adhesive by virtue of having a non-adhesive overlay.

4. A spool according to claim 1, in which the edge region of a fully coated tape is non-adhesive by virtue of having been folded back on itself.

5. A spool according to any one of claims 1 to 4, in which the non-adhesive edge region is rendered visibly distinct from the adhesive region.

6. A spool according to claim 5, in which the non-adhesive edge region is coloured differently from the rest.
